(19) United States
(12) Patent Application Publication
(10) Pub. No.: US 2026/0253932 A1
(43) Pub. Date: Aug. 27, 2026

(54) POWER GENERATING APPARATUS, SYSTEM AND METHOD FOR UTILISING OF THE CHEMICAL ENERGY OF A FLOWING IONIC MEDIUM, IN PARTICULAR WASTE WATER

(71) Applicant: Alina GUNYA-KOVACS, Dág (HU)

(72) Inventor: András GUNYA, Dág (HU)

(21) Appl. No.: 19/162,804

(22) PCT Filed: Sep. 26, 2023
(86) PCT No.: PCT/HU2023/050064

§ 371 Date: Sep. 5, 2025

(30) Foreign Application Priority Data
Mar. 8, 2023 (EP) 23000036.6

(51) Int. Cl. H01M 8/20; H01M 8/04746; H01M 8/08; H01M 8/1016

(52) U.S. Cl. CPC H01M 8/20; H01M 8/04746; H01M 8/08; H01M 8/1016

(57) ABSTRACT

The invention relates to a power generating apparatus (10) for utilising the chemical energy of a flowing ionic medium (100), in particular waste water, comprising a frame (12) and an anode (14) and a cathode (16) fixed to the frame (12) and together defining an open space (200), the space (200) between the anode (14) and the cathode (16) having an inlet opening (210) to allow the flowing ionic medium (100) to enter the space (200) and an outlet opening (220) to allow the flowing ionic medium (100) to leave the space (200), and the space (200) is separated from the outside by means of a flow slowing element (20) which allows the ionic medium (100) to pass through the inlet opening (210). The invention also relates to a system for generating electricity and a method for utilising the chemical energy of a flowing ionic medium (100), in particular waste water.

The invention relates to a power generating apparatus for utilising the chemical energy of a flowing ionic medium, in particular waste water.

The invention further relates to a power generating system comprising a plurality of electrically interconnected power generating apparatuses.

The invention also relates to a method for utilising the chemical energy of a flowing ionic medium, in particular waste water.

Today, the global energy crisis looks even more dramatic than in previous years. We can no longer deny the fact that the Earth's non-renewable resources and energy reserves could be completely exhausted in the next few generations. Industry, transport, commerce and households use most of the energy on the planet. Energy production—especially its extraction and use—can be a cause of ecological disaster as well as causing serious damage to the environment and living organisms. Environmental degradation, the risk of depletion, the continuous growth of the population and the ever-increasing consumption make it necessary to turn as soon as possible to renewable energy sources and energy carriers that do not damage our environment and are sustainable in the long term.

Our planet's resources currently fall into two main categories. One is the set of non-renewable resources, including minerals and fossil fuels such as oil, gas and coal. These are currently the main sources of energy on the planet and will soon become one of the most important problems facing humanity. The other group is the set of renewable resources, including solar, wind and water energy, biomass and geothermal energy. The first condition for our survival is therefore to stop using non-renewable fossil (oil, gas, coal) and radioactive energy and to switch to renewable energy sources.

There is a long history of harnessing energy from the sun, wind and water, but the exploitation of electrical energy from biological or chemical by-products (e.g. waste water) is still in its infancy. In addition, while the number of hours of sunshine, wind and other energy sources are limited, flowing, ionically charged media such as waste water are available continuously, regardless of the weather. In the US, there have been experiments to investigate the possibility of generating electricity from waste water. The researchers worked with bacterial colonies of sewage sludge. The idea behind their experiments was to use the electrons released during the decomposition process of the micro-organisms to make use of the anode and cathode. The experiments were carried out with microbes at the bottom of the sewage ponds, which is a complicated and cumbersome method in many respects, and the existence of the microbes needed for the experiment cannot be guaranteed in all circumstances. Their power-generating units were not able to produce voltages higher than 0.4 V. (The American experiment, “Electricity from waste water”, can be found, among other things, at https://autopro.hu/szolgaltatok/szennyvizbol-elektromos-aram/128361).

The galvanic cell is used to convert chemical energy into electrical energy. In the classic galvanic cell, a copper and zinc electrode are placed in a tank filled with dilute sulphuric acid, acting as the anode and cathode for generating electricity. The chemical action causes the copper electrode (cathode) to become positively charged as electrons escape from it into the ionic medium between them, in this case sulphuric acid. The electrons from this sulphuric acid enter the zinc electrode (anode), which thus becomes negatively charged due to the electron surplus. Due to the constant balancing of the anode and cathode, the electrons are constantly migrating in the galvanic cell system, generating an electric voltage which, depending on the voltage, can supply the consuming devices with current. The potential difference between the anode and the cathode determines the voltage, which is in turn determined by the difference in electrochemical voltage between the metals that make up the electrodes. The galvanic cell can only be used until the sulphuric acid in it is “exhausted”, because in this closed system certain chemical processes take place after a certain time, which means that the electrons are no longer able to migrate continuously between the anode and the cathode. The material of the electrodes and the electrolyte fluid (electron transport medium) can of course vary.

We recognised that ionic mediums, such as waste water, which are by-products of biological or chemical processes, can act as electrolytes in power generators based on the principle of the galvanic cell, and are therefore suitable for the production of electricity. It is also recognised that these ionic mediums are continuously produced, so that they are renewed and exchanged, providing an essentially inexhaustible source of energy.

We recognised that the majority of these ionic mediums are flowing or being flowed (e.g. in aeration basins of sewage treatment plants), so the ions in the medium are not depleted or transformed in a way that they are not suitable for electricity production.

We also recognised that waste water is particularly suitable for electricity generation because it contains large amounts of ions and is also subject to flow during the treatment process. It is also recognised that the use as an electrolyte has a positive impact on the composition of the waste water, as ammonia is broken down in the electricity generation process, and therefore the efficiency of the waste water treatment process is increased. This synthesis could open up new horizons in the field of environmental protection and alternative electricity production, as it also involves the purification of biologically contaminated, environmentally harmful by-products during electricity production.

We also recognised that by using a power generating apparatus in which the ionic medium as an electrolyte is continuously exchanged, the chemical energy of the ionic medium can be efficiently converted into electrical energy. The continuous exchange of the electrolyte can be achieved by flowing the ionic medium through the power generating apparatus, but it is also recognised that the flow of the ionic medium must be slowed down sufficiently to allow the necessary chemical reactions to take place between the anode and cathode and to generate electricity. Otherwise, no current is generated because the fast flow rate prevents a sufficiently long residence time of an ionic fluid with a certain charge in the vicinity of the anode and cathode. This means that there is not enough time for the electrochemical processes necessary for current generation to take place.

The invention aims to provide an apparatus and method free from the disadvantages of prior art solutions. In particular, it is an object of the invention to provide an apparatus and method for generating electricity by means of which the chemical energy inherent in flowing ionic medium can be continuously and efficiently converted into electrical energy.

The invention also aims to provide a power generating apparatus and method for purifying waste water.

The problem according to the invention has been solved by the power generating apparatus according to claim 1, the power generating system according to claim 9, and the method according to claim 10.

According to the invention, the power generating apparatus comprises an anode, a cathode and an open space enclosed by the anode and the cathode, through which space the flowing ionic medium is allowed to pass by appropriately slowing down the ionic medium flowing through the space by means of a flow slowing element.

Preferred embodiments of the invention are defined in the dependent claims.

Further details of the invention will be explained with the help of a drawing using examples. It is in the drawing

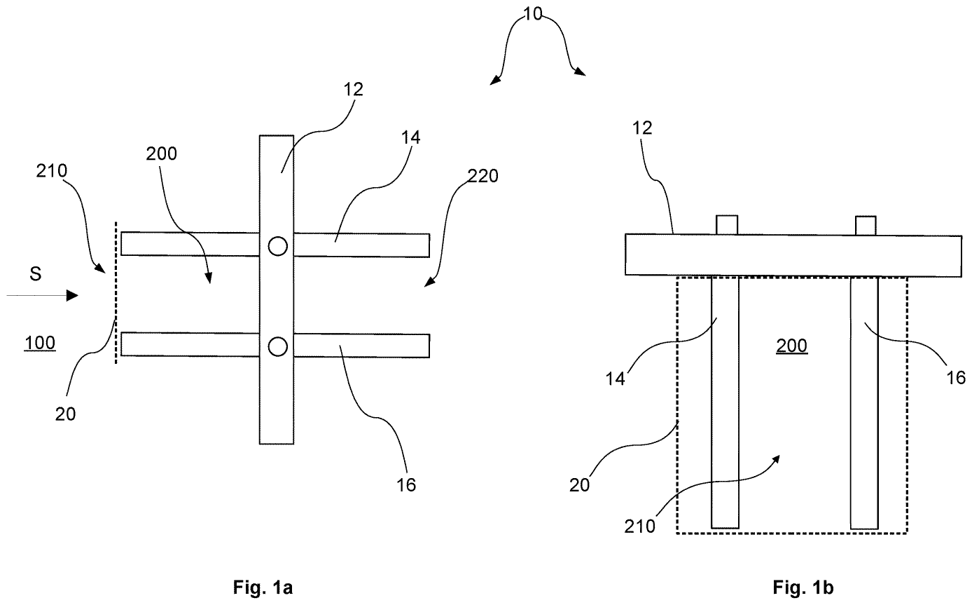

FIG. 1a is a schematic top view of an exemplary embodiment of a power generating apparatus according to the invention;

FIG. 1b is a schematic front view of the power generating apparatus shown in FIG. 1a;

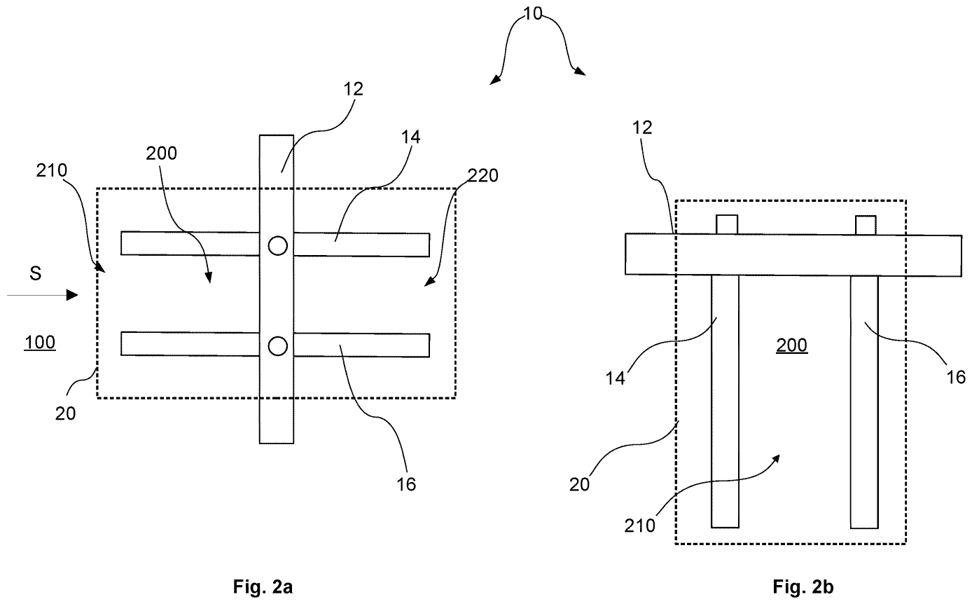

FIG. 2a is a schematic top view of a second exemplary embodiment of a power generating apparatus according to the invention;

FIG. 2b is a schematic front view of the power generating apparatus shown in FIG. 2a;

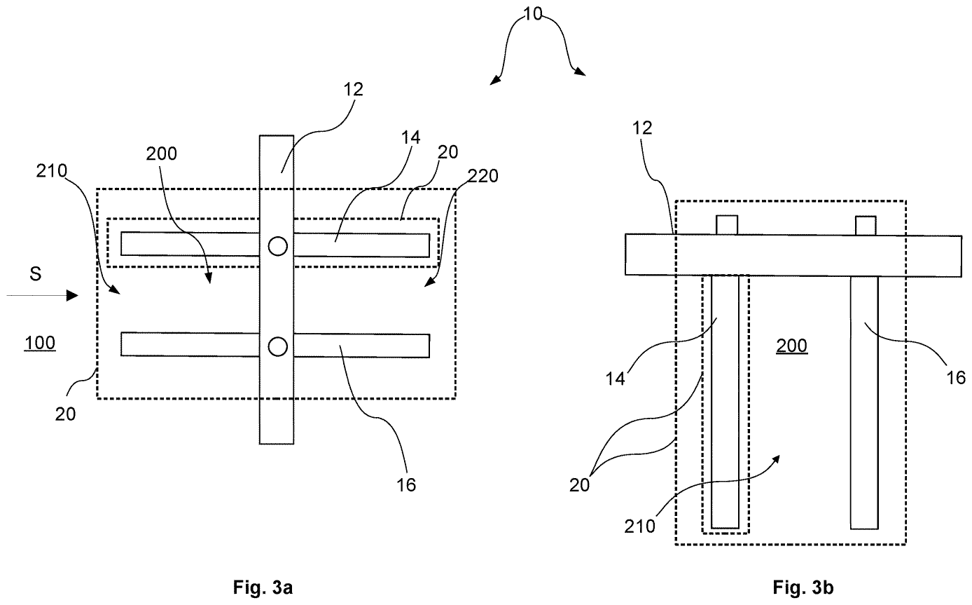

FIG. 3a is a schematic top view of a third exemplary embodiment of a power generating apparatus according to the invention;

FIG. 3b is a schematic front view of the power generating apparatus shown in FIG. 3a;

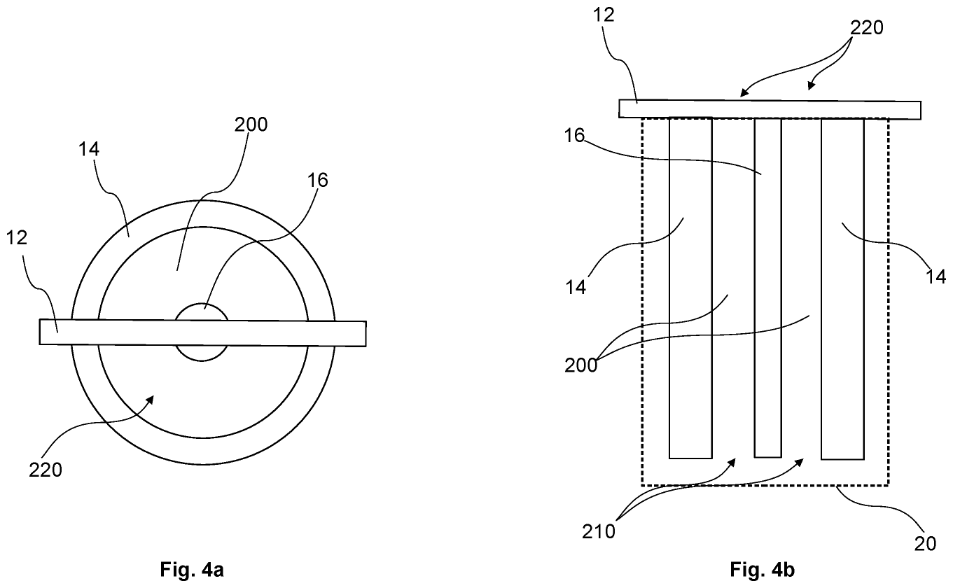

FIG. 4a is a schematic top view of a fourth exemplary embodiment of a power generating apparatus according to the invention;

FIG. 4b is a schematic side sectional view of the power generating apparatus shown in FIG. 4a;

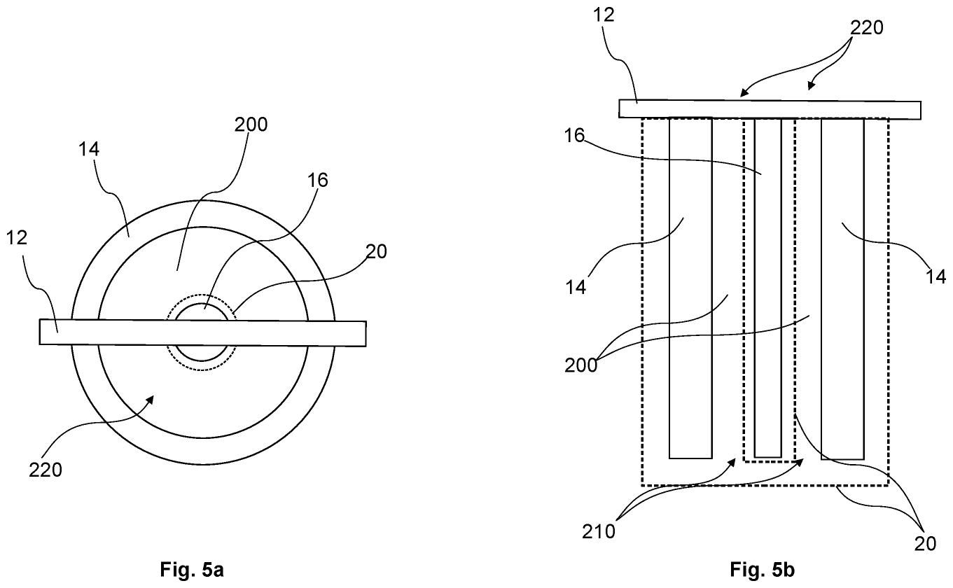

FIG. 5a is a schematic top view of a fifth exemplary embodiment of a power generating apparatus according to the invention;

FIG. 5b is a schematic side sectional view of the power generating apparatus shown in FIG. 5a;

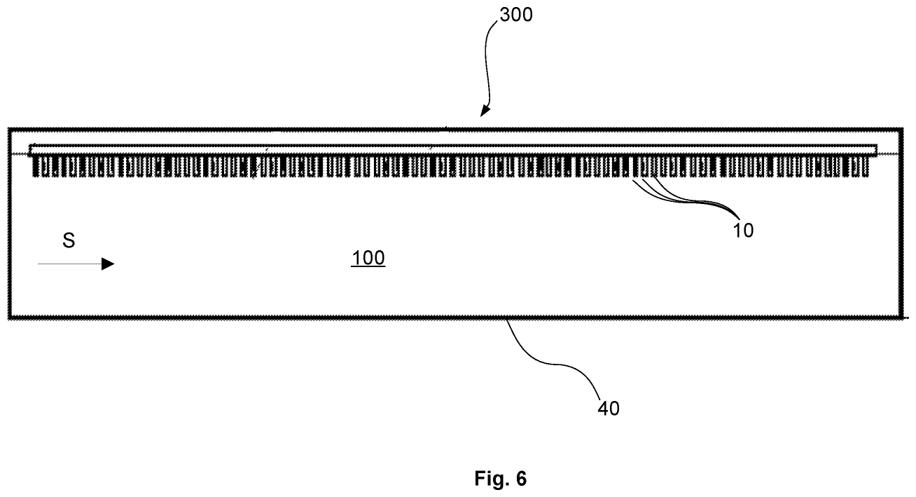

FIG. 6 is a schematic side sectional view of an exemplary embodiment of a power generating system according to the invention;

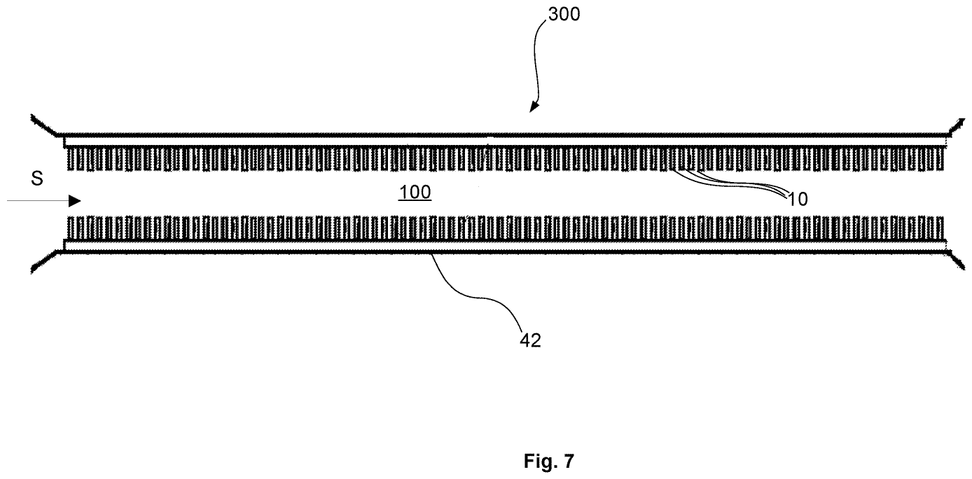

FIG. 7 is a schematic side sectional view of another possible embodiment of a power generating system according to the invention.

FIG. 1a is a schematic top view of an exemplary embodiment of a power generating apparatus 10 according to the invention. The power generating apparatus 10 is for utilizing the chemical energy of a flowing ionic medium 100, in particular waste water. In the context of the present invention, the term “flowing ionic medium 100” is interpreted broadly to include any fluid, gaseous or vaporous mobile medium in which ions carrying an electric charge are present in a significant quantity. Examples of such mediums 100 are found in waste water treatment plants, sewer systems, stormwater drainage systems, landfills and yard waste disposal systems in recirculating catch basins, and such medium 100 may include metal-working plants, battery factories, organic material processing plants (e.g. animal processing), car washes, biological and chemical by-products.

The apparatus 10 comprises a frame 12, and an anode 14 and a cathode 16 fixed to the frame 12 and together defining an open space 200. The frame 12 is preferably made of an electrically insulating material resistant to the ionic medium 100, such as plastic. In a particularly preferred embodiment, the frame 12 is made of recycled plastic. The material of the anode 14 and the cathode 16 is preferably also selected to be resistant to the ionic medium 100. Since the potential difference between the anode 14 and the cathode 16 is determined by the difference in electrochemical potential of the metals that constitute them, it is preferable to use metals or alloys with the largest possible standard potential difference as materials for the anode 14 and the cathode 16, as is known to the skilled person. Thus, in one possible embodiment, the anode 14 is aluminium and the cathode 16 is a lead alloy, in another possible embodiment, the anode 14 is magnesium and the cathode 16 is iron, etc.

In a particularly preferred embodiment, the distance between the anode 14 and the cathode 16 is between 0.1 and 0.4 mm, preferably between 0.2 and 0.3 mm. The anode 14 and the cathode 16 may be in the form of flat plates arranged parallel to each other, as can be seen in FIGS. 1a-3b. In contrast, FIGS. 4a-5b show embodiments in which the anode 14 is configured as a rod and the cathode 16 is configured as a cylindrical shell concentrically surrounding the anode 14. It is noted that, in some cases, the cathode 16 may be configured as a rod and the anode 14 may be configured as a cylindrical shell surrounding the cathode 16. Obviously, the anode 14 and cathode 16 may have other shapes than those described above (not shown in the figures), and the spacing of the anode 14 and cathode 16 may also vary spatially, for example, in the case of non-parallel flat plates. In this case, the minimum distance between anode 14 and cathode 16 is preferably chosen to be between 0.1 and 0.4 mm, more preferably between 0.2 and 0.3 mm.

The anode 14 and the cathode 16 together define the open 200 space between the anode 14 and the cathode 16. The space 200 is provided with an inlet opening 210 to allow the flowing ionic medium 100 to enter the space 200 and an outlet opening 220 to allow the flowing ionic medium 100 to exit the space 200. That is, the inlet opening 210 is the opening in the space 200 through which the medium 100 flows into the space 200, and the outlet opening 220 is the opening through which the medium 100 flows out of the space 200. The shape of the space 200 is determined by the shape of the anode 14 and the cathode 16. For example, in the embodiments shown in FIGS. 1a-3b, the open space 200 is rectangular in shape, whereas in the embodiments shown in FIGS. 4a-5b, it is cylindrical.

In the apparatus 10 according to the invention, the space 200 is separated from the outside at least from the direction of the inlet opening 210 by means of a flow slowing element 20 permeable to the ionic medium 100. The function of the element 20 is to slow down the medium 100 entering the space 200 through the inlet opening 210 to such an extent that the exchange of the medium 100 in the space 200 is not so rapid that electrochemical processes cannot take place between the anode 14 and the cathode 16. It is noted that the design of the element 20 must of course take into account the typical flow rate of the medium 100, so that for example, a faster flowing medium 100 may require an element 20 that slows down the medium 100 more, and a slower flowing medium 100 may require an element 20 that slows down the medium 100 less. This allows the electrons to travel freely and an electric current to be generated. In a particularly preferred embodiment, the flow slowing element 20 is configured to slow the velocity of the ionic medium 100 entering the space 200 through the inlet opening 210 to a maximum of 0.4 m/s.

In order to fulfil the above function, the element 20 may be arranged, for example, directly in the inlet opening 210 as shown in FIGS. 1a and 1b, or even further away from the inlet opening 210 (see, e.g., FIGS. 2a-3b). In a possible embodiment, the flow slowing element 20 may also be arranged at the outlet opening 220, or the flow slowing element 20 may be arranged in a manner that surrounds the entire space 200, as observed, for example, in FIGS. 2a-3b. In embodiments 3a-3b and 5a-5b, the anode 14 and/or the cathode 16 are also individually surrounded by flow slowing elements 20, which further slows down the flow of the medium 100 between the anode 14 and the cathode 16, i.e. the medium 100 can remain in the vicinity of the anode 14 and/or the cathode 16 for even longer and thus the electrochemical processes can take place even more efficiently. The material of the flow slowing element 20 may be any semi-permeable mesh, membrane technology, fabric mesh and similar materials that do not prevent the power generating function from being performed by any chemical reaction. The element 20 is preferably formed as a mesh of electrically insulating material, such as a plastic or glass mesh. The design and sizing of the element 20 should also take into account the need to minimise the build-up of contaminants (e.g. sludge, bacteria, etc. in the case of waste water) that may be present in the medium 100, so as not to clog the walls of the element 20. For example, the surface of the element 20 can be coated with a dirt repellent coating. This will ensure that the power generating apparatus 10 requires very little maintenance.

The invention also relates to a power generating system 300 comprising a plurality of electrically interconnected power generating apparatuses 10 according to the invention. By electrically connecting the apparatuses 10 in series or parallel, higher voltage or electrical power can be achieved. The apparatuses 10 may be arranged on a common frame 12, or the frame 12 of each apparatus 10 may be interconnected. In the embodiment shown in FIG. 6, the system 300 is arranged on top of the aeration basin 40 of a waste water treatment plant such that the apparatuses 10 of the system 300 are embedded in the medium 100. The inlet openings 210 of the apparatuses 10 are arranged opposite the flow direction S of the medium 100, so that the medium 100 can flow through the spaces 200 of the apparatuses 10. In the other possible embodiment shown in FIG. 7, the medium 100 flows in a pipe 42, for example a waste water pipe 42. Here, the system 300 is fixed to the inner wall of the pipe 42.

The invention also relates to a method for utilizing the chemical energy of a flowing ionic medium 100, in particular waste water. The method comprises providing at least one power generating apparatus 10 according to the invention, which is placed in a flowing ionic medium 100, for example waste water, such that the inlet opening 210 of the power generating apparatus 10 is turned opposite to the direction of flow S. In the vicinity of the flow generating apparatus 10, the flow rate of the ionic medium 100 is slowed down by means of the flow slowing element 20 and the slowed down ionic medium 100 is introduced through the inlet opening 210 into the space 200 and is forced to flow through the space 200. In other words, the medium 100 is introduced into the space 200 by passing it through the element 20. The element 20 exerts a resistance on the medium 100, so that the flow velocity of the medium 100 is reduced to the desired value after passing through the element 20. As mentioned earlier, the design of the element 20 must take into account the normal flow rate of the medium 100 and the flow rate that we wish to maintain in the space portion 200. In a particularly preferred embodiment, the flow velocity in the space 200 is at most 0.4 m/s, preferably between 0.1 and 0.4 m/s, more preferably 0.3 m/s.

In a preferred embodiment, a plurality of power generating apparatuses 10 are provided, and the power generating apparatuses 10 are electrically interconnected.

If we consider only the effects on the ionic mediums that are constantly changing or flowing on the Earth in waste water treatment plants, it can be concluded that there is a clear interest of economic operators in this sector, mainly because of the possibility of selling electricity. The development of the waste water sector is a public cost with significant cost implications, and the generation of electricity could make this segment an economically viable and profitable sector. This would change the priorities for infrastructure development in the world, and more sewage treatment plants could be built, as the ions in the sewage could be used to generate electricity by building more treatment collection points. If, in addition to the existing large centralised treatment plants, more small treatment plants were built, even with smaller containerised solutions, the problem of overloading of treatment plants would also be eliminated, because their operation would be adapted to local water use. Because of overloading, treatment technology is still inadequate in many places, and the creation of smaller treatment plants would also mean that even cleaner water could be released back into the environment. Containerisation is also becoming a more common solution, due to the ease of deployment of mobile units of cleaning technology, which, combined with power generation equipment, would offer huge potential for exploitation. Implementation of the invention presented here would allow the plants to supply electricity to any consumer in addition to their own, even as charging stations for electric cars.

Various modifications to the above disclosed embodiments will be apparent to a person skilled in the art without departing from the scope of protection determined by the attached claims.

1. A power generating apparatus (10) for utilising the chemical energy of a flowing ionic medium (100), in particular waste water, characterised by comprising a frame (12) and an anode (14) and a cathode (16) fixed to the frame (12) and together defining an open space (200), the open space (200) between the anode (14) and the cathode (16) having an inlet opening (210) to allow the flowing ionic medium (100) to enter the open space (200) and an outlet opening (220) to allow the flowing ionic medium (100) to leave the open space (200), and wherein a flow slowing element (20) on the apparatus (10) controls flow rate of the flowing ionic medium (100) through open space (200).

2. The power generating apparatus (10) according to claim 1, characterized in that the flow slowing element (20) is formed as a mesh made of an electrically insulating material, preferably as a plastic mesh.

3. The power generating apparatus (10) according to claim 1, characterized in that the flow slowing element (20) is configured to slow down the velocity of the ionic medium (100) entering the space (200) through the inlet opening (210) to a velocity of up to 0.4 m/s.

4. The power generating apparatus (10) according to claim 1, characterized in that the distance between the anode (14) and the cathode (16) are spaced from one another at a distance is between 0.1 and 0.4 mm.

5. The power generating apparatus (10) according to claim 1, characterized in that the flow slowing element (20) is arranged in the inlet opening (210).

6. The power generating apparatus (10) according to claim 1, characterized in that at the outlet opening (220) a flow slowing element (20) is arranged.

7. The power generating apparatus (10) according to claim 1, characterized in that the flow slowing element (20) is configured to surround the entire space (200).

8. The power generating apparatus (10) according to claim 1, characterized in that the anode (14) and/or the cathode (16) are also individually surrounded by flow slowing element (20).

9. The power generating apparatus (10) according to claim 1, characterized in that the frame (12) is made of plastic.

10. A power generation system (300), characterized in that it comprises a plurality of electrically interconnected power generating apparatuses (10) according to claim 1.

11. A method for utilizing the chemical energy of a flowing ionic medium (100), in particular waste water, characterized in that
providing at least one power generating apparatus (10) according to claim 1,
placing the at least one power generating apparatus (10) in a flowing ionic medium (100) such that the inlet opening (210) of the power generating apparatus (10) is oriented opposite to a direction of flow(S),
slowing down the flow velocity of the ionic medium (100) in the vicinity of the power generating apparatus (10) by means of the flow slowing element (20), and
introducing the slowed-down ionic medium (100) through the inlet opening (210) into the space (200) and allowing it to flow through the space (200).

12. The method according to claim 11, characterized in that the velocity of the ionic medium (100) entering the open space (200) through the inlet opening (210) is to between 0.1 and 0.4 m/s.

13. The method according to claim 11, characterized in that a plurality of power generating apparatuses (10) are provided and the power generating apparatuses (10) are electrically interconnected.

14. The power generating apparatus (10) according to claim 1, characterized in that the anode (14) and the cathode (16) are spaced from one another at a distance between 0.2 and 0.3 mm.

15. The method according to claim 11, characterized in that the velocity of the ionic medium (100) entering the open space (200) through the inlet opening (210) is 0.3 m/s.
